(19) United States
(12) Patent Application Publication
(10) Pub. No.: US 2004/0232142 A1
(43) Pub. Date: Nov. 25, 2004

(54) Metal food-heating tray for microwave oven

(75) Inventor: C. J. Zhu, Bao An (CN)

Correspondence Address: CHRISTIE, PARKER & HALE, LLP, PO BOX 7068, PASADENA, CA, 91109-7068, US

(73) Assignee: JINDA PLASTIC METAL PRODUCTS (SHENZHEN) CO., LTD.

(21) Appl. No.: 10/877,234

(22) Filed: Jun. 24, 2004

Related U.S. Application Data
(62) Division of application No. 10/167,777, filed on Jun. 10, 2002.

(30) Foreign Application Priority Data
Aug. 10, 2001 (CN) 01233931.8

(51) Int. Cl. H05B 6/80

(52) U.S. Cl. 219/730

(57) ABSTRACT

A microwavable metal food-heating tray for a microwave oven is provided that includes a metal tray having a bottom surface and a plurality of insulators that are evenly distributed and vulcanized on the bottom surface of the metal tray. The insulators on the bottom surface of the tray effectively detach the metal food-heating tray from the rotating tray of a microwave oven to avoid sparks resulting from electric conduction between the metal food-heating tray and the rotating tray, when the rotating tray is metal rotating tray. However, the metal food-heating tray performs equally when used in a microwave oven having a non-metal rotating tray.

### CROSS REFERENCE TO RELATED APPLICATION

This application is a divisional of U.S. patent application Ser. No. 10/167,777, filed on Jun. 10, 2002, which claims priority of Chinese Patent Application No. 01233931.8, filed on Aug. 10, 2001.

### TECHNICAL FIELD

The present utility model relates to a tray for microwave oven, especially a kind of metal food-heating tray for microwave oven.

### BACKGROUND TECHNOLOGY

As a new type of food heater, the microwave oven has been widely used among the consumers. The conventional rotating trays used in microwave ovens are made of glass to facilitate the penetration of microwave. Therefore, non-metal trays are generally used for heating foods with microwave oven. Said non-metal trays are usually thick glass trays or ceramic trays. With the advancement of researches on the heating principle of microwave oven, microwave oven rotating trays made of metallic materials have been put on the market, such as metal enamel rotating trays that are characterized by light weight and strong durability, and can fully satisfy the requirement of application as an auxiliary part of microwave oven in performance. Now that microwave oven can use metal enamel rotating tray, it's undoubted that metal tray also can be used for containing foods. Therefore, metal food-heating trays for microwave oven have appeared in the market. However, it is found that in actual application metal food-heating trays can only be used together with non-metal rotating trays in microwave ovens. If it is used on metal rotating tray, it will cause sparks because of electric conduction between the two trays, and consequently the normal use of microwave oven will be affected.

Content of the Invention

The present utility model eliminates the defects of the afore-mentioned metal food-heating trays that cannot be used on metal rotating tray of microwave oven by providing a kind of metal food-heating tray for microwave oven that can be used on non only non-metal rotating tray of microwave oven but also metal rotating tray.

The metal food-heating tray for microwave oven in the present utility model includes a metal tray, whose characteristic is that insulating stands are evenly distributed at the bottom of the metal tray.

Utilizing the insulating stands at the bottom of the tray, the metal food-heating tray for microwave oven in the present utility model is effectively detached from the metal rotating tray of microwave oven to avoid sparks resulting from electric conduction between the two metal trays. Said metal food-heating tray for microwave oven performs equally as the metal food-heating tray for use with other than microwave ovens, and it can be used together with both non-metal and metal rotating tray in the microwave oven.

The particular structure of the metal food-heating tray for microwave oven in the present utility model is as shown in the following drawings and embodiment.

### BRIEF DESCRIPTION OF THE DRAWINGS

FIG. 1: Structural schematic drawing of metal food-heating tray for microwave oven;

FIG. 2: Section view of the metal food-heating tray for microwave oven in line A-A of FIG. 1.

### THE PREFERRED EMBODIMENT

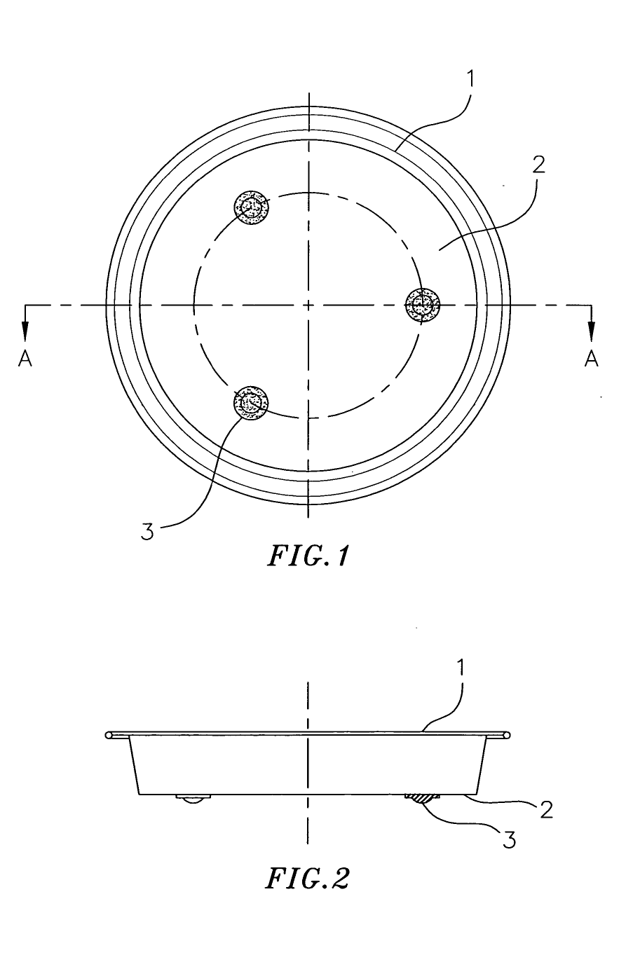

From FIG. 1 and FIG. 2, It is clearly shown that this is a circular metal food-heating tray for microwave oven; there are three insulating stands 3 on the bottom surface 2 of the metal tray 1; the three insulating stands 3 are symmetrically distributed on the bottom surface 2 of the metal tray 1; and the insulating stands 3 are stuck on the metal tray 1 through vulcanization. The said insulating stands 3 are made by rubber.

What is claimed is:

1. A food-heating system comprising:
a microwave oven having a metal rotating plate;
a metal tray having an inner surface for receiving a food to be heated and a bottom surface; and
a plurality of insulating stands evenly distributed on the bottom surface of the metal tray, wherein each insulating stand has a top surface and a bottom surface, such that the top surface of each insulating stand is fixedly attached directly to the bottom surface of the metal tray and wherein the bottom surface of each insulating stand is disposed directly in contact with the metal rotating plate.

2. The food-heating system as recited in claim 1, wherein the top surface of each insulating stand is non-moveably and fixedly attached directly to the bottom surface of the metal tray.

3. The food-heating system as recited in claim 1, wherein each of the plurality of insulating stands are made of rubber.

4. The food-heating system as recited in claim 1, wherein the plurality of insulating stands are each attached to the bottom surface of the metal tray through vulcanization.

5. The food-heating system as recited in claim 1, wherein the plurality of insulating stands comprises three insulating stands that are symmetrically distributed on the bottom surface of the metal tray.

6. A method of heating food comprising:
providing a microwave oven having a metal rotating plate;
providing a metal tray having an inner surface for receiving a food to be heated and a bottom surface;
providing a plurality of insulating stands, wherein each insulating stand has a top surface and a bottom surface;
fixedly attaching the top surface of each insulating stand directly to the bottom surface of the metal tray;
placing the bottom surface of each insulating stand in direct contact with the metal rotating plate; and
activating the microwave oven to heat the food.

7. The method as recited in claim 6, further comprising fixedly and non-moveably attaching the top surface of each insulating stand directly to the bottom surface of the metal tray.

8. The method as recited in claim 6, further comprising forming each of the plurality of insulating stands from a rubber material.

9. The method as recited in claim 8, wherein each of the plurality of insulating stands are attached to the bottom surface of the metal tray through vulcanization.

10. The method as recited in claim 6, wherein the plurality of insulating stands comprises three insulating stands that are symmetrically distributed on the bottom surface of the metal tray.
